(19) United States
(12) Patent Application Publication
(10) Pub. No.: US 2006/0215023 A1
(43) Pub. Date: Sep. 28, 2006

(54) Method and system of displaying user interest data at a surveillance station

(76) Inventors: Charles Kevin Coonce, Parma, MI (US); Mark James Maloney, Jackson, MI (US)

Correspondence Address: ICE MILLER LLP, ONE AMERICAN SQUARE, SUITE 3100, INDIANAPOLIS, IN, 46282-0200, US

(21) Appl. No.: 11/087,836

(22) Filed: Mar. 23, 2005

(51) Int. Cl. H04N 7/18; H04N 9/47

(52) U.S. Cl. 348/143

(57) ABSTRACT

A system, method and computer readable medium storing a computer program for displaying user interest data at a surveillance station is disclosed. Each surveillance station includes a controller, a video camera, a communication module, and a display screen. The surveillance station can be placed in one of a surveillance mode and an emergency response mode. Real time video data is transmitted from the surveillance station to the operations center in both the surveillance mode and the emergency response mode. Real time video data is received from the operations center at the surveillance station in emergency response mode. The real time video received at the surveillance station is displayed on the display screen in the emergency response mode and user interest data is displayed on the display screen in the surveillance mode.

### FIELD OF THE INVENTION

The present invention relates generally to a surveillance system. In particular, the invention relates to a method and system for providing a surveillance station with a display screen where interest data is displayed on the display screen when the surveillance station is in surveillance mode.

### BACKGROUND OF THE INVENTION

Emergency situations often require the immediate implementation of appropriate emergency procedures to minimize injuries and loss of human life. For example, in the event of a building emergency, such as for example a fire, providing immediate effective professional guidance to the building occupants during a building evacuation may save lives. Also in the event of large scale emergencies, such as for example, a hurricane, an earthquake or tornado, providing prompt warnings and guidance via direct communication with the people in the vicinity of the emergency situation may be instrumental in minimizing panic and guiding people in the vicinity of the emergency situation to locations of greater safety.

Public areas are sometimes placed under surveillance and monitored by live personnel at remote monitoring centers. However, in the event of an emergency, personnel at the monitoring centers do not typically themselves provide guidance to the people in the vicinity of the emergency situation. Such monitoring centers may contact an emergency response facility, such as for example, the police department or fire department to respond to the emergency situation.

Strategically placed emergency telephones may be available to a user to request emergency assistance in the event of an emergency situation. However, the locations of such telephones may not be readily known to customers, guests or other visitors present at the facility. In addition, the verbal information that might be conveyed to and from the user in an emergency is limited to the communication skills of the user and the emergency personnel recipient at the other end of the phone line and the audio quality of their communications. Visitors such as tourists may not speak the same language as the emergency personnel. In emergencies, environmental noise and/or hearing loss suffered by the user in the emergency may greatly impede the flow of useful information.

In addition, and depending on the severity of the emergency, the user of one-way real-time surveillance systems described above may not be able to speak or communicate with enough length or clarity to provide the needed information to the emergency monitoring personnel. Smoke and other conditions may impair the unprotected user's breathing due to contaminatation of the ambient air at the emergency site, thus inhibiting or foreclosing meaningful oral communications from the emergency user's location.

In order to overcome some of these potential disadvantages, others have suggested surveillance systems involving audio communication and one-way real-time video surveillance whereby an emergency monitoring person can view conditions at the location of the emergency user. See, e.g. U.S. Patent Application Publication No. US 2003/0227540 and U.S. Pat. No. 6,538,689. While these types of one-way real-time video surveillance systems may provide some useful visual information to the emergency personnel, the persons present at the emergency site must rely on the quality of the audio communication from the emergency personnel, and visa versa. Such limitations prevent, for example, display of location maps, exits, and best escape routes to the user. In addition, if the user does not share a common language with the emergency personnel the former's requests and the latter's instructions may be meaningless.

It is desirable, therefore, to provide systems and methods for responding to an emergency situation that overcomes one or more of the prior art limitations described above.

### SUMMARY OF THE INVENTION

One aspect of the invention provides a surveillance system. The surveillance system includes a controller communicatively coupled to video camera, a communications module, and a display screen. The controller is operable to place the surveillance station in one of a surveillance mode and an emergency response mode. The communication module is operable to transmit real time video data from the video camera to an operations center in both the surveillance mode and the emergency response mode and to receive real time video data from the operations center in the emergency response mode. The display screen is operable to display user interest data in the surveillance mode and the real time video data received from the operations center in the emergency response mode.

Another aspect of the invention provides a method for displaying user interest data at a surveillance station. The method includes placing a surveillance station in one of a surveillance mode and an emergency response mode, transmitting real time video data from the surveillance station to an operations center in both the surveillance mode and the emergency response mode, receiving real time video data from the operations center at the surveillance station in the emergency response mode, and displaying user interest data on a display screen in the surveillance mode and the real time video data received from the operations center in the emergency response mode.

Another aspect of the invention provides a computer readable medium storing a computer program for displaying user interest data at a surveillance station. The computer program includes computer readable code for placing a surveillance station in one of a surveillance mode and an emergency response mode, computer readable code for transmitting real time video data from the surveillance station to an operations center in both the surveillance mode and the emergency response mode, computer readable code for receiving real time video data from the operations center at the surveillance station in emergency response mode, computer readable code for displaying the real time video data received from the operations center on a display screen in emergency response mode, and computer readable code for displaying user interest data on the display screen in surveillance mode.

Another aspect of the present invention is a surveillance system as described above that includes interactive user data permitting the user to interact with the operations center in the surveillance mode, the emergency mode and/or in both modes.

Another aspect of the invention provides a method of financing the placement of a surveillance station at a site. The method includes placing the surveillance station at a site, displaying user interest data associated with a first entity on the surveillance station, and receiving compensation from the first entity for displaying the user interest data.

### BRIEF DESCRIPTION OF THE DRAWINGS

The present invention is illustrated by way of example and not limited in scope to the accompanying figures, in which like references indicate similar elements, and in which:

FIG. 1 is a schematic block diagram of an embodiment of a real time emergency response surveillance system in accordance with the principles of the present invention;

FIG. 2 is a schematic block diagram of an embodiment of a surveillance station in accordance with the principles of the present invention;

FIG. 3 is an illustration of an embodiment of the surveillance station in accordance with the principles of the present invention;

FIG. 4 is a schematic block diagram of an embodiment of an operations center in accordance with the principles of the present invention;

FIG. 5 is a schematic block diagram of an embodiment of a content distribution center in accordance with the principles of the present invention;

FIG. 6 a-b is a flowchart of one embodiment of a method of displaying user interest data at the surveillance station when the surveillance station is in surveillance mode in accordance with the principles of the present invention; and

FIG. 7 a-b is a flowchart of one embodiment of a method of operating the surveillance station in emergency response mode in accordance with the principles of the present invention.

### DETAILED DESCRIPTION OF THE PREFERRED EMBODIMENTS

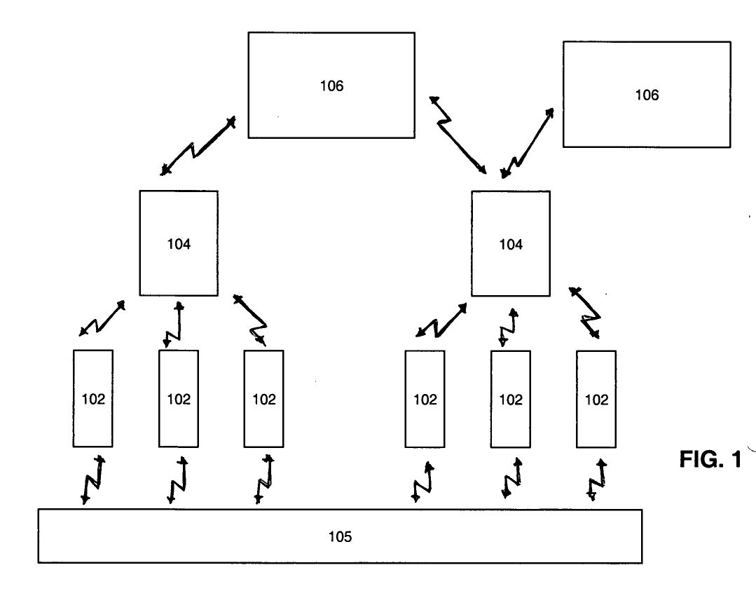

FIG. 1 is a schematic diagram of one embodiment of a real time emergency response surveillance system 100, in accordance with the principles of the present invention. The real time emergency response surveillance system 100 includes one or more standalone surveillance stations 102, one or more operations centers 104 and one or more content distribution centers 105. Each operations center 104 is communicatively coupled to one or more surveillance stations 102. In one embodiment, each content distribution center 105 is directly communicatively coupled to one or more surveillance stations 102. In another embodiment, each of the content distributions centers 105 are communicatively coupled to one or more surveillance stations 102 via an operations center 104. In one embodiment, one or more of the operations centers 104 are communicatively coupled to one or more emergency response centers 106.

In one embodiment, each surveillance station 102 is configured to transmit and receive audio and video data to and from an operations center 104 via communication networks that enable high speed audio and video communication. Examples of such communication systems include, but are not limited to, T1 line, T3 line, OC3 fiber, OC12 fiber, OC48 fiber, OC192 fiber, digital subscriber line (DSL) or any other high speed communication lines that may be apparent to one having ordinary skill in the art. A combination of wired and wireless communications networks may also be employed without departing from the spirit of the invention.

In another embodiment each surveillance station 102 is configured to transmit and receive audio data and video data to and from an operations center 104 via a satellite communication network. The surveillance station 102 may be communicatively coupled to a router via a wired communication link, a wireless communication link or a combination wired and wireless communication link. The router may be communicatively coupled to the satellite dish via a wired communication link, a wireless communication link or a combination wired and wireless communication link. The operations center 104 may include one or more operations center advisor stations. Each operations center advisor station may be communicatively coupled to the router via a wired communication link, a wireless communication link or a combination wired and wireless communication link. The router may be communicatively coupled to the satellite dish via a wired communication link, a wireless communication link or a combination wired and wireless communication link.

In one embodiment, each surveillance station 102 is configured to transmit and receive data to and from a content distribution center 105 via communication networks that enables high speed audio and/or video communication. Examples of such communication systems include, but are not limited to, T1 line, T3 line, OC3 fiber, OC12 fiber, OC48 fiber, OC192 fiber, digital subscriber line (DSL) or any other high speed communication lines that may be apparent to one having ordinary skill in the art. A combination of wired and wireless communications networks may also be employed without departing from the spirit of the invention.

In another embodiment each surveillance station 102 is configured to transmit and receive data to and from a content distribution center 105 via a satellite communication network. The surveillance station 102 may be communicatively coupled to a router via a wired communication link, a wireless communication link or a combination wired and wireless communication link. The router may be communicatively coupled to the satellite dish via a wired communication link, a wireless communication link or a combination wired and wireless communication link. The content distribution center 105 may be communicatively coupled to the router via a wired communication link, a wireless communication link or a combination wired and wireless communication link. The router may be communicatively coupled to the satellite dish via a wired communication link, a wireless communication link or a combination wired and wireless communication link.

In one embodiment, one or more of the operations centers 104 are communicatively coupled to an emergency response center 106. Each operations center 104 is configured to receive audio and video data from an emergency response center 106 via communication networks that enable high speed audio and video communication. Examples of such communication systems include, but are not limited to, T1 line, T3 line, OC3 fiber, OC12 fiber, OC48 fiber, OC192 fiber, digital subscriber line (DSL) or any other high speed communication lines that may be apparent to one having ordinary skill in the art. A combination of wired and wireless communications networks may also be employed without departing from the spirit of the invention.

In another embodiment one or more of the operations centers 104 is configured to receive audio data and video data from one or more emergency response centers 106 via a satellite communication network. The operations center 104 may be communicatively coupled to a router via a wired communication link, a wireless communication link or a combination wired and wireless communication link. The router may be communicatively coupled to the satellite dish via a wired communication link, a wireless communication link or a combination wired and wireless communication link. The emergency response center 106 may be communicatively coupled to the router via a wired communication link, a wireless communication link or a combination wired and wireless communication link. The router may be communicatively coupled to the satellite dish via a wired communication link, a wireless communication link or a combination wired and wireless communication link.

In one presently preferred embodiment, each of the surveillance stations 102 can be placed in one of two operating modes: a surveillance mode and an emergency response mode. The surveillance mode is the default surveillance station 102 operating mode. In one embodiment, when a surveillance station 102 is in surveillance mode, surveillance video cameras and microphones are active and real time audio/video data is continuously transmitted from the surveillance station 102 to the operations center 104 for real time evaluation by one or more operations center advisors. In another embodiment, the surveillance camera is active and real time video is transmitted from the surveillance station 102 to the operations center 104 in surveillance mode. The operations center 104 is preferably staffed with one or more operations center advisors around the clock. The operations center advisors may include specialists, such as for example, building security experts, medical experts and/or other specialists that specialize in responding to different types of emergency situations.

User interest data is displayed on a surveillance station display screen in surveillance mode. In one embodiment, the operations center 104 selects and transmits the selected user interest data to the surveillance station 102 for display at individual surveillance stations 102. In another embodiment, a content distribution center 105 coordinates the organization and transmission of selected user interest data for individual surveillance stations 102. The received user interest data is stored locally at the surveillance station 102. The selected user interest data may depend upon the location of that surveillance station 102 and on the specific requests of the entity authorizing the placement of the surveillance station 102. For example, a surveillance station 102 located in a bank may display user interest data directed to banking needs. Alternatively, if the station is located in a retail space, such as a shopping mall or large store, advertisements of the store(s) and other commercial facilities and their respective goods and services may be displayed on the screen. Stations located in areas frequented by tourists may display historical and local interest information, including displays in several different languages.

The display of user interest data at a surveillance station 102 may unobtrusively and/or attractively draw the attention of people passing by a surveillance station 102 to the location, availability and nature of the surveillance station 102 in a non-emergency environment. This increases the probability that people will recall the location and availability of the surveillance station 102 in the event of an emergency situation.

Further, such unobtrusive attraction may facilitate clearer video surveillance of an individual's appearance in certain embodiments of the present invention. Such information may be useful in the event that subsequent events require identification of individuals present at the location, such as identification of airline passengers or visitors at government or public facilities that may later become sites of emergency situations, or children that become separated from their care-givers

In the event of an emergency situation that requires immediate implementation of emergency procedures, such as for example, a building evacuation, the operations center 104 places all of the surveillance stations 102 in the area affected by the emergency situation in emergency response mode. An alarm system is activated at each of the surveillance stations 102 that have been placed in emergency response mode to draw attention to that surveillance station 102. A two way real time audio/video communication channel is immediately established between each of the surveillance stations 102 in emergency response mode and the operations center 104. Real time audio/video data continues to be transmitted from the surveillance station 102 to the operations center 104. Real time audio/video data of a live operations center advisor is transmitted from the operations center 104 and displayed on the surveillance station display screen in emergency response mode. The operations center advisor instructs the people in the vicinity of the surveillance station 102 regarding the appropriate emergency safety and/or evacuation procedures. Depending on the nature of the emergency, such information may include oral and/or visual information as to the nearest safe exit or refuge or best evacuation route(s) away from the emergency. Different operations center advisors may interface with different surveillance stations 102 and provide location specific instructions.

In one embodiment, the operations center 104 can establish a communications channel between selected surveillance stations 102 and an emergency response center 106 via the operations center 104. The operations center 104 routes real time audio/video of an emergency specialist received from the emergency response center 106 to the appropriate surveillance stations 102. Examples of emergency response centers 106 include but are not limited to, the fire department, the police department, local hospitals and any government agency, such as for example, Homeland Security. National or international agencies may also be connected to the notification system, such as earthquake, weather, flood and Tsunami warning organizations.

One or more surveillance stations 102 are strategically placed throughout a designated area to facilitate security monitoring of the premises or area and to enable operations center advisors to provide effective emergency specific guidance to persons on the premises. The surveillance stations 102 maybe used to monitor areas, such as for example, public and private buildings, indoor stadiums, outdoor stadiums, sports arenas, concert halls, museums amusement parks, beaches, national monuments and important government or historic sites. The surveillance stations 102 may be, for example, strategically placed throughout a building to monitor building security and provide interactive emergency specific guidance in the event of an emergency situation. For example, operations center advisors may provide building evacuation guidance in the event of a fire in the building. If located out of doors, the advisors may provide maps of appropriate exit or evacuation routes or medical and first aid treatments centers, or to locations or food, water and transportation centers. It should be noted while a number of examples of placement sites for the surveillance stations 102 have been described, the real time surveillance emergency response system 100 can be implemented in any area where emergency response guidance may be necessary to promote individual safety in the event of an emergency situation.

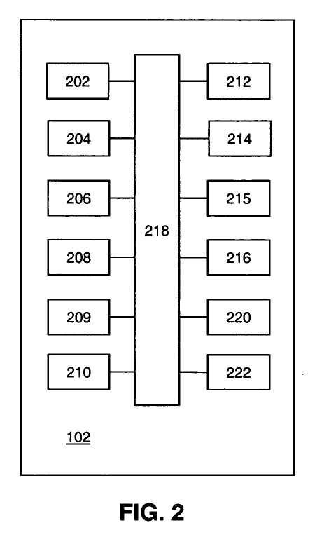

Referring to FIG. 2, a schematic block diagram of a preferred embodiment of a surveillance station 102 in accordance with the principles of the present invention is shown. The surveillance station 102 includes a controller 202 that is communicatively coupled to a local memory 204, a communication module 206, a display screen 208, a user interface 209, a video camera 210, a microphone 212, one or more speakers 214, a printer 215, and an alarm system 216 via a network 218. In one embodiment, the surveillance station 102 includes a global positioning (GPS) unit 220.

In one embodiment, the controller 202 is a digital signal processor (DSP). In another embodiment the processor may be implemented as a microcontroller, microprocessor, controller, host processor, or communications processor. The processor may be implemented as an application specific integrated circuit (ASIC). In another embodiment, the processor may be implemented as a processor working in conjunction with a central processing unit (CPU) performing the function of a general purpose processor. The processor executes various computer programs that control programming and operational modes of electronic and mechanical systems within the surveillance station 102, and communications via the communication module 206.

The communication module 206 includes a transmitter and a receiver. The transmitter transmits the real time video data recorded by the video camera 210 and the real time audio data picked up by the microphone 212 from the surveillance station 102 to the operations center 104. The receiver receives communication data from the operations center 104 including real time audio/video data of the operations center advisor. The received video data is displayed in real time on the display screen 208 and the received audio data is transmitted in real time via the speakers 214. In one embodiment, the communication module 206 also receives user interest data from the content distribution center 105. In another embodiment, the communication module 206 transmits user supplied data collected from a user at the surveillance station 102 from the surveillance station 102 to the content distribution center 105.

In one embodiment the display screen 208 is a cathode ray tube (CRT) display. In another embodiment, the display screen 208 is a liquid crystal (LCD) display. In another embodiment, the display screen 208 is a touch screen display. While a number of types of display screens 208 have been described other types of display screens 208 are also considered to be within the scope of the invention. The display screen 208 may be communicatively coupled to the controller 202 via a wired or wireless communication network.

As described above, in one embodiment, the user interface 209 may be a touch screen display 208. In one embodiment, the user interface 209 may be a pointer controller. For example, the user interface 209 may be a roller ball mouse, an optical mouse or a wireless mouse configured to manipulate a pointer and make selections on the display screen 208. Other types of user interfaces 209 that may be used include, but are not limited to, a keyboard, a bar code reader, and a card reader. The user interface 209 may include a combination of different user interfaces 209. Use of such interfaces may permit the user to choose the language he or she is most comfortable with for further communication with the operation center. In addition, the user may input information to the operation center by selection of appropriate prompts or menus on the screen, even if the user cannot hear or respond to the emergency personnel's instructions due to injury or environmental conditions.

The video camera 210 is strategically positioned to achieve site specific surveillance objectives. In one embodiment, the video camera 210 is positioned on a rotating base to provide maximum coverage of the area under surveillance. In another embodiment, the operations center advisor can remotely control the position of the video camera 210. In another embodiment, the video camera 210 is located remotely from the surveillance station 102 and is communicatively coupled to the controller 202 and the communication module 206 via a wired or wireless communication network.

In one embodiment, the printer 215 consists of a thermal printer. In another embodiment, the printer 215 is a dot matrix printer. In another embodiment, the printer 215 is an ink jet printer. Other types of printers may be used without departing from the spirit of the invention. A user may choose to print selected user interest data via the user interface 209 to make selections presented on the display screen 208. The selected user interest data is printed on the printer 215.

The alarm system 216 is activated when the operations center 104 places the surveillance station 102 in emergency response mode. The controller 202 coordinates the activation of the alarm system 216. In one embodiment, the alarm system 216 includes a siren. In another embodiment, the alarm system 216 includes a strobe light. In another embodiment, the alarm system 216 consists of a combination of a siren and a strobe light. In a preferred embodiment, the alarm system 216 includes a siren, a red strobe light and a blue strobe light.

In one embodiment, the controller 202 activates the blue strobe light when the surveillance station 102 receives a notification message. In one embodiment, the blue strobe light is activated for a pre-defined period of time following the receipt of the notification message from the operations center 104. In one embodiment, the pre-defined period of time is approximately ten seconds.

In one embodiment, the controller 202 activates the red strobe light, the blue strobe light and the siren when the operations center 104 places the surveillance station 102 in emergency response mode. The alarm system 216 remains activated until the surveillance station 102 is reset by the operations center 104. The operations center 104 resets the surveillance station 102 once the operations center determines that the emergency situation has been resolved or abated. It should be noted that while a number of different alarm systems 216 have been described, other types of alarm systems 216 are also considered to be within the scope of the invention.

In one embodiment, the surveillance station 102 includes a back up power supply (not shown). The back up power supply is activated responsive to a failure of the primary power supply powering the surveillance station 102. In one embodiment, the back up power supply has the capacity to power the surveillance station 102 for approximately an hour.

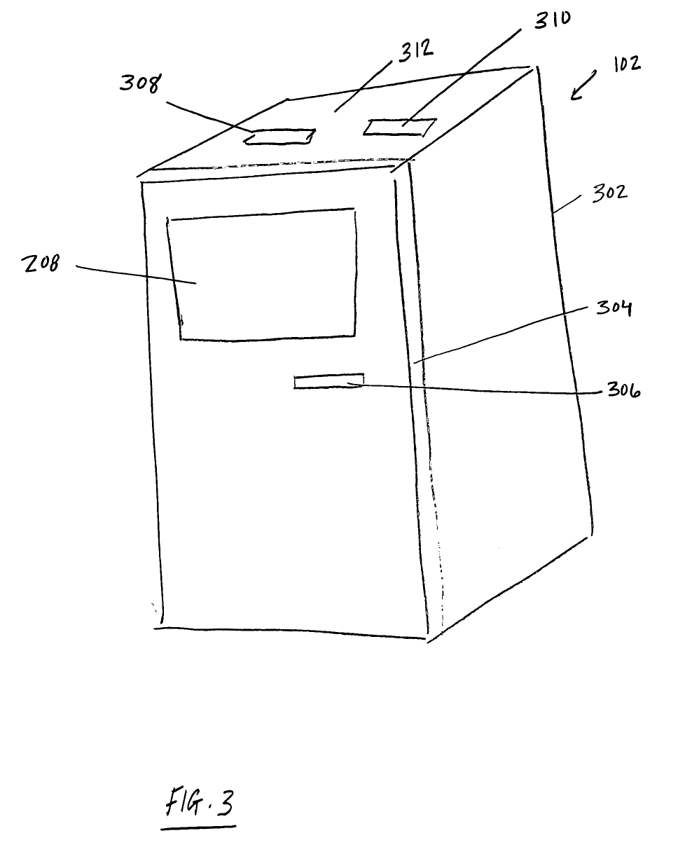

FIG. 3 shows another preferred embodiment of a surveillance station 102 in accordance with the principles of the present invention. Referring to FIG. 2 and FIG. 3, the surveillance station 102 is integrated into a cabinet 302.

The cabinet 302 includes a cabinet door 304. The surveillance station circuitry, including, the controller 202, local memory 204, the communication module 206, and the printer 215 are disposed within the cabinet 302. The display screen 208 is held in place within an opening in the upper section of the cabinet door 304. A printer slot 306 disposed below the display screen 208 and extends through the cabinet door 304. The printed material is guided from the printer 215 disposed within the cabinet 302 through the printer slot 306.

The alarm system 216 includes a red strobe light 308, a blue strobe light 310, and a siren. The red strobe light 308 and the blue strobe light 310 are disposed on an upper surface 312 of the cabinet 302.

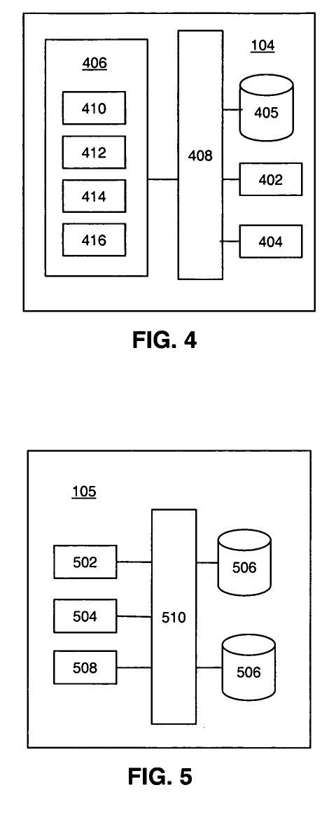

Referring to FIG. 4, a schematic block diagram of a preferred embodiment of an operations center 104 in accordance with the principles of the present invention is shown. The operations center 104 includes a operations controller 402, one or more communication modules 404, one or more operations databases 405, and one or more operations center advisor stations 406 communicatively coupled via a network system 408. Each operations center advisor station 406 is equipped with a video camera 410, a display screen 412, a microphone 414 and one or more speakers 416.

In one embodiment, the operations controller 402 is a digital signal processor (DSP). In another embodiment the processor may be implemented as a microcontroller, microprocessor, controller, host processor, or communications processor. The processor may be implemented as an application specific integrated circuit (ASIC). In another embodiment, the processor may be implemented as a processor working in conjunction with a central processing unit (CPU) performing the function of a general purpose processor. The processor executes various computer programs that control programming and operational modes of electronic and mechanical systems within the operations center 104 and manages the flow of audio/video into and out of the operations center 104.

The communication module 404 includes a transmitter and a receiver. The transmitter transmits the real time video data recorded by the video camera 410 and the real time audio data picked up by the microphone 414 from operations center advisors station to the surveillance station 102. The receiver receives the real time audio/video data from the surveillance stations 102. The operations controller 402 routes the received audio/video data to the appropriate operations center advisors station 406 for display on the display screen 412 and for transmission via the speakers 416.

All of the real time audio/video data received at the operations center 104 from the one or more surveillance stations 102 and all of the real time audio/video data transmitted from the operations center 104 to a surveillance station 102 is stored in the operations database 405.

In one embodiment the display screen 412 is a cathode ray tube (CRT) display. In another embodiment, the display screen 412 is a liquid crystal (LCD) display. While a number of types of display screens 412 have been described other types of display screens 412 are also considered to be within the scope of the invention. The display screen 412 may be communicatively coupled to the operations controller 402 via a wired or wireless communication network.

Referring to FIG. 5, a schematic block diagram of another preferred embodiment of a content distribution center 105 in accordance with the principles of the present invention is shown. The content distribution center 105 includes one or more data modems 502, one or more content distribution servers 504, one or more databases 506 and one or more content distribution stations 508 communicatively coupled via a network system 510.

The content distribution center 105 is staffed with one or more content distribution advisors. The content distribution advisors create and update the user interest data, and coordinate the distribution of selected user interest data to individual surveillance stations 102 via the content distribution stations 508. The user interest data is stored in the databases 506. The user interest data selected by a content distribution advisor for transmission to a particular surveillance station 102 may depend on the location of that surveillance station 102 and on specific requests made by the entity authorizing the placement of the surveillance station 102. When a content distribution advisor authorizes the transmission of selected user interest data to a surveillance station 102 via a content distribution station 508, a content distributions server 504 retrieves the selected user interest data from a database 506. The retrieved user interest data is forwarded to a data modem 502 for transmission to the designated surveillance station 102.

The user interest data includes non-interactive and interactive user interest data. A user can selectively request the display of interactive user interest data via the user interface 209. In one preferred embodiment, the user interest data may include product data. Product manufactures and product retailers wishing to advertise their goods and/or services, work with a content distribution advisor to coordinate the creation and display of their product data at one or more designated surveillance stations 102. Examples of product data include, but are not limited to, product advertisement data and product promotional data. Product promotional data may include, but is not limited to, health care tips associated with particular products, coupons and rebates.

In another embodiment, the user interest data may include displays of forms configured to accept user supplied data via a user interface at the surveillance station 102. Such forms include, but are not limited to, sweepstakes entry forms, market survey forms, or requests for additional information regarding an advertised product. The user can provide the information requested in the forms via the user interface 209. In one embodiment, prompts are provided to the user to ensure that the requested information is supplied.

In cases where the user requests additional information regarding an advertised product, the user supplied data includes user contact data. Examples of user contact data include, but are not limited to, user name, user address, user phone number, and user email address. The user contact data is initially stored in the surveillance station 102 and then forwarded to the content distribution center 105 responsive to a data request from the content distribution center 105. The content distribution center 105 forwards the user contact data to the appropriate product retailer or manufacturer so that they can directly provide the user with the requested product data.

In another preferred embodiment, the user interest data may be configured in view of the area where the surveillance station 102 is being placed. For example, if the surveillance station 102 is located in a school, the user interest data may include school related data, such as for example class schedule information. If the station is located in a tourist attraction, information about the local attraction may be displayed.

In one embodiment, the entity responsible for authorizing the placement of one or more surveillance stations 102 may be granted limited access to the database 506 to modify and/or update the user interest data displayed on those surveillance stations 102.

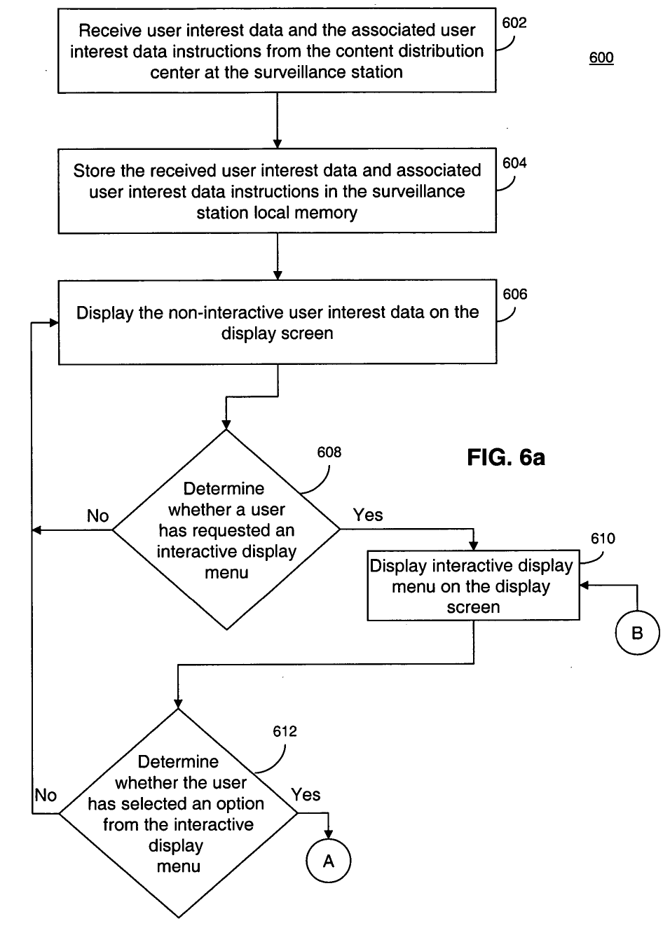

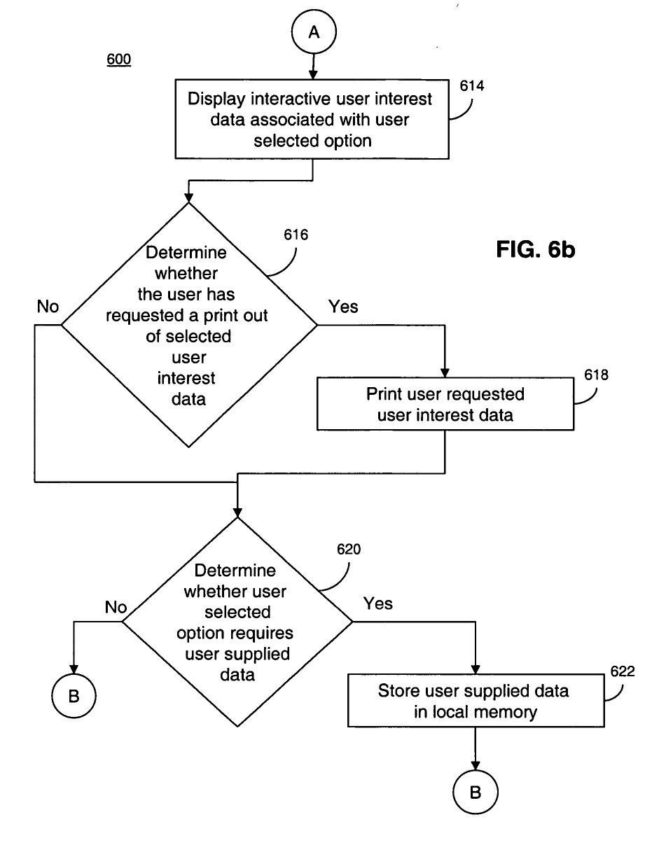

Referring to FIG. 6a-b, a flowchart illustrating a presently preferred embodiment of a method of displaying user interest data at the surveillance station 102 when the surveillance station 102 is in surveillance mode 600 in accordance with the principles of the present invention is shown. The method 600 begins at step 602 with the surveillance station 102 receiving user interest data and user interest data instructions from the content distribution center 105. The content distribution advisor identifies the specific user interest data for each individual surveillance station 102. The user data instructions provide the controller 202 with instructions for displaying the user interest data on the display screen 208 at the surveillance station 102. In one embodiment, the user interest data instructions define the sequence for displaying non-interactive user interest data. In one embodiment, the user interest data instructions define the hierarchical organization of the interactive user interest data displays.

The content distribution advisor identifies and flags the specific user interest data and associated user interest data instructions for the surveillance station 102 at the content distribution station 508. The content distribution server 504 retrieves the flagged user interest data from the database 506 and routes the retrieved user interest data and the associated user interest data instructions to data modem 502. The data modem 502 forwards the user interest data and the associated user interest data instructions to the surveillance station 102. At step 604, the controller 202 stores the user interest data and the associated user interest data instructions in the local memory 204. At step 606, the controller 202 displays the non-interactive user interest data on the display screen 208 in accordance with the stored user interest data instructions.

In another embodiment, the user interest data and the associated user interest data instructions are maintained at the content distribution center 105. A constant communication link is maintained between the surveillance station 102 and the content distribution center 105. The user interest data is transmitted to the surveillance station 102 for display on the display screen 208 in accordance with the user interest data instructions.

In one embodiment, the display screen 208 is a touch screen display screen. The touch screen display displays the user interest data and functions as the user interface 209. While the controller 202 is displaying non-interactive user interest data in accordance with user interest data instructions on the display screen 208, a user has an option of interrupting the display sequence by requesting that an interactive display menu outlining interactive user interest data display options be displayed on the display screen 208 via the user interface 209.

The interactive user interest data may include one or more interactive display menus. The interactive display menu may include one or more selectable options. For example, the interactive user interest data options may include a listing for different types of product data. The interactive display menu may provide the user with the option of selecting a particular product from a list of different products and view the associated product data. Each product data listing may include product advertisements and product promotions associated with that product data. The interactive display menu may provide the user with the selectable option of viewing product promotional data associated with a displayed product advertisement.

The controller 202 continuously monitors the display screen 208 and the user interface 209 to determine whether a user has requested an interactive display menu outlining interactive user interest data options at step 608. If a user has not requested that an interactive display menu be displayed on the display screen 208, the controller 202 continues to display the non-interactive user interest data on the display screen 208 in accordance with the user interest data instructions as indicated in step 606.

If the controller 202 determines that a user has requested an interactive display menu, the interactive display menu is retrieved from the local memory 204 and is displayed on the display screen 208 at step 610. In one embodiment, there is a plurality of interactive display menus available for selection by a user. In another embodiment, the interactive display menus are organized in a hierarchical manner.

At step 612, the controller 202 determines whether the user has selected an option from the interactive display menu. If the user does not select an option from the interactive display menu within a predetermined period of time, the controller 202 resumes the display of the non-interactive user interest data on the interactive display screen 208 in accordance with the associated user interest data instructions as indicated in step 606. If the controller 202 determines that the user has selected a particular option from the interactive display menu, the controller 202 displays the interactive user interest data associated with the selected option at step 614.

The user is provided with the option of printing interactive user interest data. In one embodiment, the user is provided with the option of printing the interactive user interest data displayed on the display screen 208. In another embodiment, the user is provided with the option of printing additional information associated with displayed interactive user interest data. For example, if the displayed interactive user interest data consists of an advertisement for allergy medication, the user may be provided with the option of printing the side effects associated with taking the allergy medication. The user may also be provided with the option of printing coupons or rebates offers associated with the allergy medication. In another embodiment, the user is provided with the option of printing non-interactive user interest data by providing a print request via the user interface 209.

The controller 202 monitors the display screen 208 and the user interface 209 to determine whether the user has requested a print out of any interactive user interest data at step 616. If the controller 202 determines that the user has requested a print out of selected interactive user interest data, the controller 202 directs the printer 215 to print the requested interactive user interest data at step 618. The method then proceeds to step 620. If the controller 202 determines that the user has not requested a print out, the method proceeds directly to step 620.

In one embodiment, the interactive user interest data includes one or more different types of forms. The interactive display menu includes options for selecting one or more forms. For example, the interactive display menu may provide the user with the option of filling out a customer satisfaction survey form for a product, a sweepstake entry form, or a request form for additional product data associated with an advertised product from a product retailer or product manufacturer.

At step 620, the controller 202 determines whether the user has selected an option, such as for example to fill out a form, that requires the user to provide user supplied data. Examples of user supplied data include, but are not limited to, user contact data and user marketing data. If the user has selected such an option, in one embodiment, the controller 202 displays the requested form on the display screen 208 and the user provides the user supplied data via the user interface 209. In another embodiment, the controller 202 provides the user with prompts to provide the requested user supplied data. The controller 202 stores the user supplied data at step 622 and then returns to displaying the interactive display menu on the display screen 208 at step 610. If the controller 202 determines that the user has not selected an option that requires the user to provide user supplied data, the controller 202 displays the interactive display menu on the display screen 208 as indicated in step 610.

While a particular sequence of steps have been described above, it should be noted that a method 600 having substantially similar steps or steps in a different sequence are also considered to be within the scope of the invention. Also if any of the interactive display menus or interactive user interest data displays remain dormant for a pre-defined period of time, or in other words no further user input is provided via the user interface 209 for a pre-defined period of time, the controller 202 resumes the display of non-interactive user interest data on the display screen 208 in accordance with the associated user interest data instructions.

In the event of an emergency situation requiring the implementation of emergency procedures, such as for example, a building evacuation, the operations center 104 issues an emergency signal to all of the surveillance stations 102 in the area affected by the emergency situation. The controller 202 places the surveillance station 102 in emergency response mode responsive to the received emergency signal. A real time audio/video communication channel is established between the surveillance station 102 and the operations center 104 to enable the transmission of audio/video data from the operations center 104 to the surveillance station 102 thereby creating a two way real time audio/video communication channel between the surveillance station 102 and the operations center 104. An operations center advisor at the operations center 104 can assess the impact of the emergency situation in the vicinity of the surveillance station 102 based on the audio/video data received from the surveillance station 102. The operations center advisor provides live audio/video emergency response guidance to the people in the area. Based on a review of the audio/video data feedback received from the surveillance station 102 location, the emergency response guidance can be responsively modified to adjust to potentially changing circumstances at the location of the surveillance station 102.

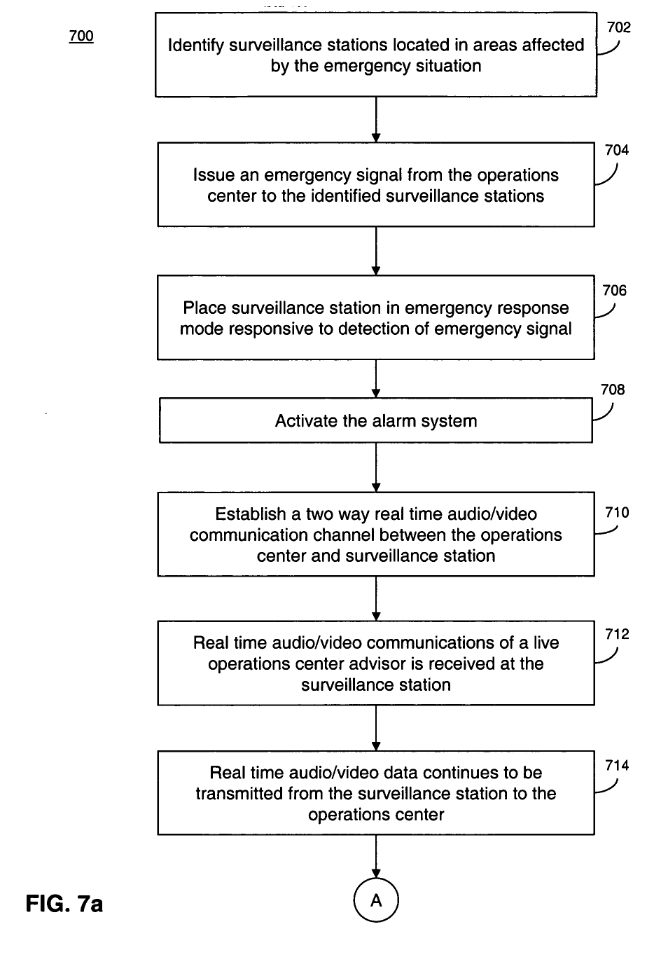

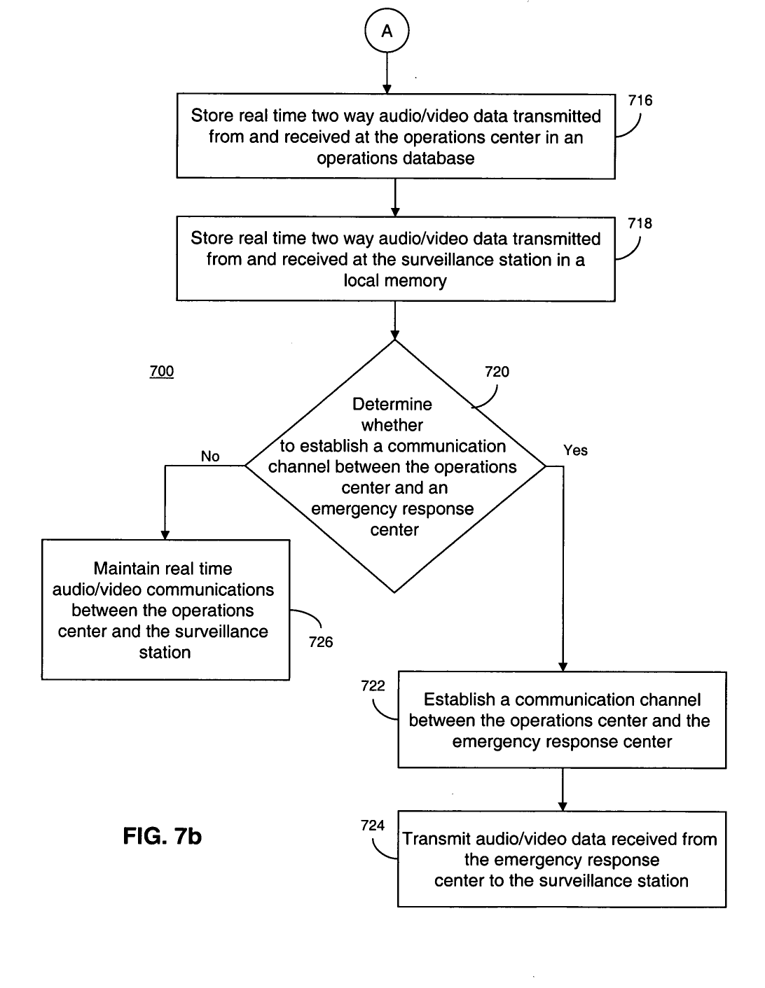

Referring to FIG. 7a-b, a flowchart of one embodiment of a method of operating the surveillance station 102 in emergency response mode 700 in accordance with the principles of the present invention is shown. In the event of an emergency situation, the method 700 begins at step 702 with the operations center 104 identifying the surveillance stations 102 located in the areas affected by the emergency situation. An emergency signal is issued to each of the identified surveillance stations 102 at step 704. When the controller 202 at each of the identified surveillance stations 102 detects the emergency signal, the controller 202 responsively places the surveillance station 102 in emergency response mode at step 706 and activates the alarm system 216 at step 708. In one embodiment, the alarm system 216 consists of a red strobe light, a blue strobe light and a siren. In one embodiment, the alarm system 216 remains activated until the surveillance station 102 is returned to surveillance mode. While one example of an alarm system 216 has been described, alternative types of alarm systems are also considered to be within the scope of the invention.

At step 710, a real time audio/video communication link is established between the surveillance station 102 and the operations center 104 to enable the transmission of real time audio/video data from the operations center 104 to the surveillance station 102 thereby creating a two way real time audio/video communication channel between the surveillance station 102 and the operations center 104. At step 712, the live real time audio/video data of the operations center advisor received from the operations center 104 at the surveillance station 102 is displayed on the display screen 208 and transmitted via the speakers 214. This permits the people at the surveillance station 102 to hear and see the operations center advisor at the operations center 104 via the display screen 208 and the speakers 214 on a real time basis.

At step 714, live real time audio/video data picked up by the video camera 210 and the microphone 212 continues to be transmitted from the surveillance station 102 to the operations center 104. The real time audio/video data received at the operations center 104 is routed to an operations advisor station 406 and displayed on the display screen 412 and transmitted via the speakers 416. The operations center advisor at the operations center 104 can hear and see the people in the vicinity of the surveillance station 102 on a real time basis.

The real time two-way audio/video communication channel permits the operations center advisor at an operations center 104 to communicate directly with the people in the vicinity of the surveillance station 102. This permits the operations center advisor to evaluate the emergency situation at the surveillance station 102 and provide the people in the vicinity of the surveillance station 102 with the appropriate guidance based on the received feedback. If warranted, the operation center may cause a full screen or partial screen interactive display of data during the emergency mode, permitting the user to input selections without the need for oral communications in a manner similar to that used to access, display and interact with the interactive data in the non-emergency mode.

At step 716. the real time audio/video data transmitted from and received at the operations center 104 is stored in the operations database 405 and at step 718, the real time audio/video data transmitted from and received at the surveillance station 102 is stored in the local memory 204. This preserves a record of all communications between the operations center 104 and surveillance stations 102 for future assessment and review.

At step 720, the operations center advisor at the operations center 104 determines whether to establish a communication channel between the operations center 104 and an emergency response center 106. In the event of a widespread emergency situation, such as for example, an earthquake, a hurricane, a tornado or a terrorist attack, emergency response agencies, such as for example The Department of Homeland Security, may take a more active role in informing and guiding people to safety. If the operations center 104 determines that an emergency response center 106 may be better equipped to guide people to safety, the operations center advisor establishes a communication channel between the operations center 104 and the appropriate emergency response center 106 at step 722 such that the operations center 104 is able to receive real time audio/video transmissions from the emergency response center 106.

At step 724, the audio/video transmissions received from the emergency response center 106 at the operations center 104 are transmitted from the operations center 104 to the surveillance stations 102. The controller 202 displays the received audio/video data on the display screen 208 and transmits the audio via the speakers 214. Thus people in the vicinity of the surveillance station 102 are provided with the latest status of the emergency situation as well as guidelines for dealing with the emergency situation.

If the operations center advisor determines that it is unnecessary to establish a communication channel between the operations center 104 and an emergency response center 106, two way real time audio/video communications are maintained between the operations center 104 and the surveillance station 102 and the operations center advisor continues to provide emergency situation specific guidance to the people in the vicinity of the surveillance station at step 726.

While a particular sequence of steps have been described above, it should be noted that a method 700 having substantially similar steps or steps in a different sequence are also considered to be within the scope of the invention.

The content distribution center 105 is operated by the surveillance station 102 providers. As mentioned previously, the user interest data may include product data. Potential advertisers, such as for example, product manufactures, product retailers and service providers, wishing to promote their goods and/or services can work with a content distribution advisor to coordinate the creation and/or display of their product data on one or more surveillance stations 102. In one preferred embodiment, compensation is received from the advertisers in exchange for promoting their goods and/or services on one or more surveillance stations 102. The compensation received from the advertisers is used to fund the costs associated with the manufacture, placement, operation, insurance premiums, and training associated with the placement of the surveillance stations 102 in a one or more locations. Other types of costs beyond those described may be covered by the compensation received from advertisers without departing from the spirit of the invention. Examples of such costs include decreased costs and/or increased revenue resulting from promotion of the goods and/or services of the entity that owns or leases the facility that houses the surveillance station 102.

For example, an airport manager may wish to place one or more surveillance stations 102 in an airport. The airport management contacts the surveillance station 102 provider according to the present invention and makes a request for the placement of one or more surveillance stations 102 in the airport. The surveillance station provider supplies the requested surveillance stations to the airport at a given charge, at a reduced charge or free of charge. The surveillance station 102 provider may also provide coverage of insurance costs associated with the placement of the surveillance station, and may also provide training costs associated with training selected airport personnel to operate the surveillance station 102. One or more of the costs described above are covered by the compensation received from advertisers for displaying user interest data associated with the advertisers' goods and/or services on one or more surveillance stations 102 or are covered by an overall reduction in the insurance rates for the related facility housing the surveillance stations 102.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A surveillance station comprising:
a controller operable to place the surveillance station in one of a surveillance mode and an emergency response mode;
a video camera communicatively coupled to the controller;
a communication module communicatively coupled to the controller, the communication module being operable to transmit real time video data from the video camera to an operations center in both the surveillance mode and the emergency response mode and to receive real time video data from the operations center in the emergency response mode; and
a display screen communicatively coupled to the controller, the display screen being operable to display user interest data in the surveillance mode and the real time video data received from the operations center in the emergency response mode.

2. The surveillance station of claim 1, wherein the user interest data comprises non-interactive user interest data.

3. The surveillance station of claim 1, wherein the user interest data comprises interactive user interest data.

4. The surveillance station of claim 3 wherein the interactive user interest data comprises interactive user interest data selected from a group comprising an advertisement, a coupon, a rebate form, a customer satisfaction survey form, a sweepstake entry form, or a contact information form.

5. The surveillance station of claim 1, further comprising a user interface communicatively coupled to the controller.

6. The surveillance station of claim 1 wherein the interactive user interest data comprises interactive selection of display language, emergency instructions, emergency reports, evacuation instructions, or medical instructions.

7. The surveillance station of claim 5, wherein the user interface comprises a user interface selected from the group consisting of a touch screen display, a pointer controller, a card reader, and a bar code reader.

8. The surveillance station of claim 5, wherein the controller is operable to selectively display the interactive user interest data responsive to a user input received via the user interface.

9. The surveillance station of claim 5, further comprising a local memory operable to store user supplied data received via the user interface.

10. The surveillance station of claim 8, wherein the communication module is operable to transmit the stored user supplied data to a content distribution center.

11. The surveillance station of claim 5, further comprising a printer operable to selectively print user interest data responsive to user input received via the user interface.

12. The surveillance station of claim 11, wherein the printer comprises a printer selected from a group consisting of a thermal printer, a dot matrix printer, and an ink jet printer.

13. The surveillance station of claim 1, wherein the communication module is operable to receive user interest data from a content distribution center.

14. The surveillance station of claim 13, wherein a communication channel between the surveillance station and the content distribution center is established via a communication system wherein the communication system comprises a communication system selected from a group consisting of a satellite communication system, a T1 line system, a T3 line system, an OC3 fiber system, an OC12 fiber system, an OC48 fiber system, an OC192 fiber system, and a DSL system.

15. The surveillance station of claim 1, further comprising a local memory operable to store the user interest data.

16. The surveillance station of claim 1, wherein the controller is operable to display the user interest data on the display screen in a pre-defined sequence.

17. The surveillance station of claim 1, wherein the user interest data comprises product data.

18. The surveillance station of claim 1, wherein the display screen comprises a display screen selected from the group consisting of a liquid crystal display, a touch screen display, and a cathode ray tube display.

19. A method of displaying user interest data at a surveillance station, the method comprising:
placing a surveillance station in one of a surveillance mode and an emergency response mode;
transmitting real time video data from the surveillance station to an operations center in both the surveillance mode and the emergency response mode;
receiving real time video data from the operations center at the surveillance station in the emergency response mode; and
displaying user interest data on a display screen in the surveillance mode and the real time video data received from the operations center in the emergency response mode.

20. The method of claim 19, wherein displaying the user interest data on the display screen in surveillance mode comprises displaying non-interactive user interest data.

21. The method of claim 19, further comprising displaying the user interest data in a pre-defined sequence.

22. The method of claim 17, wherein displaying the user interest data on the display screen in surveillance mode comprises displaying interactive user interest data.

23. The method of claim 22, further comprising interfacing with the user interest data via a user interface.

24. The method of claim 23, wherein displaying the user interest data on the display screen in surveillance mode further comprises:
displaying non-interactive user interest data;
interrupting the display of non-interactive user interest data responsive to a user input received via the user interface; and
displaying the interactive user interest data in accordance with the received user input.

25. The method of claim 23, further comprising storing user supplied data received via the user interface in a local memory.

26. The method of claim 25, further comprising transmitting the stored user supplied data to a content distribution center.

27. The method of claim 23, further comprising:
receiving user input via the user interface; and
printing selected user interest data based on the received user input.

28. The method of claim 19, further comprising receiving user interest data from a content distribution center.

29. The method of claim 28, further comprising storing the received user interest data in a local memory.

30. A computer readable medium storing a computer program for displaying user interest data at a surveillance station, comprising:
computer readable code for placing a surveillance station in one of a surveillance mode and an emergency response mode;
computer readable code for transmitting real time video data from the surveillance station to an operations center in both the surveillance mode and the emergency response mode;
computer readable code for receiving real time video data from the operations center at the surveillance station in emergency response mode;
computer readable code for displaying the real time video data received from the operations center on a display screen in emergency response mode; and
computer readable code for displaying user interest data on the display screen in surveillance mode.

31. The computer readable medium of claim 30, wherein the computer readable code for displaying the user interest data on the display screen comprises computer readable code for displaying non-interactive user interest data.

32. The computer readable medium of claim 30, further comprising computer readable code for displaying the user interest data in a pre-defined sequence.

33. The computer readable medium of claim 27, further comprising computer readable code for interfacing with the user interest data via a user interface.

34. The computer readable medium of claim 30, further comprising readable code for displaying the interactive user data.

35. The computer readable medium of claim 34, further comprising:
computer readable code for displaying non-interactive user interest data;
computer readable code for interrupting the display of non-interactive user interest data responsive to a user input received via the user interface; and
computer readable code for displaying the interactive user interest data in accordance with the received user input.

36. The computer readable medium of claim 34, further comprising computer readable code for storing user supplied data received via the user interface in a local memory.

37. The computer readable medium of claim 36, further comprising computer readable code for transmitting the stored user supplied data to a content distribution center.

38. The computer readable medium of claim 34, further comprising:
computer readable code for receiving user input via the user interface; and
computer readable code for printing selected user interest data based on the received user input.

39. The computer readable medium of claim 31, further comprising computer readable code for receiving the user interest data from a content distribution center.

40. The computer readable medium of claim 39, further comprising computer readable code for storing the received user interest data in a local memory.

41. A method of financing the placement of a surveillance station at a site, the method comprising:
placing the surveillance station at a site;
displaying user interest data associated with a first entity on the surveillance station; and
receiving compensation from the first entity for displaying the user interest data.

42. The method of claim 40, wherein displaying user interest data further comprises displaying user interest data promoting goods associated with the first entity.

43. The method of claim 40, wherein displaying user interest data further comprises displaying user interest data promoting services associated with the first entity.

44. The method of claim 40, further comprising using the compensation received from the first entity to offset a percentage of costs associated with providing the surveillance station.

45. The method of claim 43, wherein the costs associated with providing the surveillance station comprises costs selected from a group consisting of surveillance station manufacturing costs, surveillance station placement costs, surveillance station operation costs, surveillance station related insurance costs, and surveillance station training costs.

46. The method of claim 40, wherein placing the surveillance station at a site comprises placing the surveillance station at the site associated with a second entity.

47. The method of claim 40, wherein the first entity comprises an advertiser.
